(19) United States
(12) Patent Application Publication
(10) Pub. No.: US 2004/0203753 A1
(43) Pub. Date: Oct. 14, 2004

(54) Packet data services using a protocol that is different than a subscriber's home network GSM Protocol

(76) Inventors: Douglas Harold Rollender, Bridgewater, NJ (US); Thomas Lloyd Hiller, Glen Ellyn, IL (US)

Correspondence Address: CARLSON, GASKEY & OLDS, P.C., 400 WEST MAPLE ROAD, SUITE 350, BIRMINGHAM, MI, 48009, US

(21) Appl. No.: 10/336,159

(22) Filed: Jan. 3, 2003

(51) Int. Cl. H04Q 7/20; H04B 1/38

(52) U.S. Cl. 455/432.1; 455/552.1

(57) ABSTRACT

A wireless voice and data communication system facilitates providing packet data services to mobile subscribers even when they roam into areas that are served by a system that operates using a protocol different than the subscriber's home system protocol. In one example, a subscriber profile including appropriate authorization for packet data services that conforms to a GSM/GPRS protocol is mapped from a home location register (HLR) that uses the GSM protocol to a visitor location register that uses a CDMA/ANSI-41 protocol so that the GSM mobile subscriber obtains packet data services through provider system that uses the CDMA/ANSI-41 protocol.

### BACKGROUND OF THE INVENTION

1. Field of the Invention

This invention generally relates to wireless packet data services. More particularly, this invention relates to wireless packet data services using a protocol that is different than a mobile user's home network protocol.

2. Description of the Related Art

A number of different companies provide wireless voice and data services to mobile subscribers. Each of the service providers has a home network. Provider networks typically are at least somewhat geographically limited.

When a mobile subscriber desires wireless services in a region or area that is not directly serviced by their provider, another provider whose network services the area acts as the serving system to provide the wireless services desired by the mobile subscriber. When a mobile subscriber utilizes another providers system as a serving system, that is typically referred to as roaming.

Standards and protocols exist that allow different providers to serve a mobile user as that mobile user roams between regions that are served by different providers. For example, the ANSI-41 signaling protocol for intersystem operations has been approved by the American National Standards Institute. The ANSI-41 protocol is used by providers and their subscribers in the United States. Other protocols are used in other countries. For example, the GSM/GPRS protocol is used in much of Europe. The GSM/GPRS protocol is part of the global systems for mobile communication mobile applications protocol used in Europe.

A further complexity is introduced when a subscriber of a system using one protocol roams into a region that is served by a provider that utilizes a different protocol. For example, when a GS-M/GPRS subscriber is in the United States and desires to make a call using a wireless phone, an ANSI-41 protocol-using provider typically acts as the serving system. Standards exist for allowing the ANSI-41 serving system to obtain the necessary authorization from the GSM subscriber's home network such that the subscriber is recognized on the ANSI-41 system as a valid voice user.

For example, when a GSM subscriber desires to make a voice call in a region of the United States served by an ANSI-41 protocol using provider, the combined mobile switching center/visited location register (MSC/VLR) complex of the serving system utilizes a subscription identifier such as the International Mobile Subscription Identifier (IMSI) provided by the mobile user's mobile station. The IMSI allows the MSC/VLR complex to make appropriate contact with the home location register (HLR) of the subscriber's home network. After the MSC/VLR complex receives appropriate authorization from the HLR, a radio access network controller of the serving system facilitates the wireless voice communication on behalf of the GSM subscriber.

While advances have been made and standards have been adopted for facilitating such voice communication, the same is not true of all such packet data services. There is a need for a method of providing wireless packet data services to a GSM/GPRS subscriber, when the mobile subscriber is roaming in a region that requires using another protocol such as CDMA/ANSI-41.

This invention addresses that need and facilitates providing wireless packet data services to roaming GSM/GPRS subscribers even when the mobile user's home network operates based upon a protocol different than that used by the serving system.

### SUMMARY OF THE INVENTION

In general terms, this invention is a method of providing wireless packet data services to a mobile subscriber having a service profile that conforms to a GSM protocol regardless of the protocol used by the serving network.

One method designed according to this invention includes communicating a service profile for a mobile subscriber that conforms to a GSM protocol including permission for packet data services in conformance with the requirements of a second protocol that is different from the GSM protocol such that the packet data permission is valid in the second protocol.

In one example, the service profile of the mobile user is mapped from the GSM protocol to the second protocol, including the subscriber's permission for packet data service. In one particular example a GSM subscriber protocol and packet data service permission is mapped from the GSM/GPRS protocol to the CDMA/ANSI-41 protocol. Accordingly, the inventive arrangement allows for a roaming mobile user to obtain packet data services even in regions that are served by a system that utilizes a protocol different than the mobile user's home system protocol.

The various features and advantages of this invention will become apparent to those skilled in the art from the following detailed description. The drawing that accompanies the detailed description can be briefly described as follows.

### BRIEF DESCRIPTION OF THE DRAWING

FIG. 1 schematically illustrates a wireless communication system that provides packet services to roaming mobile users.

### DETAILED DESCRIPTION

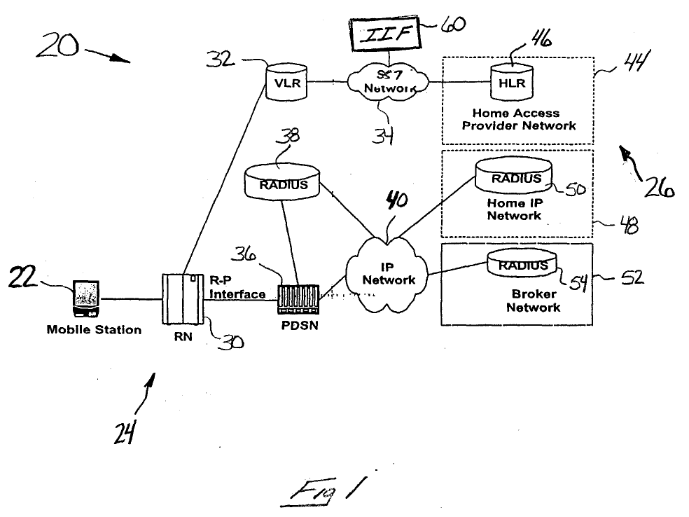

FIG. 1 schematically illustrates a wireless communication system 20 that facilitates providing voice and packet data services to a mobile subscriber using a mobile station 22. The schematic illustration of a mobile station 22 in FIG. 1 should not be construed to be limiting in any sense. A variety of mobile stations that are capable of wireless packet data communication may be used.

The illustrated system 20 is schematically divided into a visited access provider network side 24 and a home access provider network side 26. The visited access provider network side 24 acts as the serving system for the user of the mobile station 22. The home access provider network side 26 represents the mobile subscriber's home network, which is remotely located from the serving system side 24.

In one example, the serving system side 24 is in the United States and uses the CDMA/ANSI-41 protocol to support packet data services to roaming subscribers. In this particular example, the home network side 26 is located in Europe and utilizes the GSM/GPRS protocol. This invention is not limited to such an arrangement and is useful with a variety of different protocols.

The serving system side 24 includes a radio access network controller 30 that operates in a conventional manner to facilitate voice communications through the mobile station 22. A visitor location register (VLR) 32 has access to a SS7 network 34 such that the VLR 32 can utilize the IMSI received from the mobile station 22 to obtain the necessary information to facilitate voice communication for the mobile user of the mobile station 22. References to VLR 32 in this description are to be understood to include a MSC/VLR complex as appropriate for a particular provider's network.

The radio access network controller 30 utilizes conventional air and R-P interfaces to facilitate the desired voice or data communications with the mobile station 22. The serving system side 24 also includes a packet data serving node 36 and a radius 38 that operate in a conventional manner to provide packet data services to the mobile user of the mobile station 22. The radius 38 and packet data serving node 36 communicate with an IP network 40 in a known manner to achieve the desired packet data services at the mobile station 22.

The home network side 26 includes a home access provider network 44, which includes the necessary hardware, software, firmware and combinations of those to maintain a provider network. A home location register (HLR) 46 of the network 44 includes a database of the various subscribers, their profiles and information whether the subscribers are registered for packet data services. The HLR 46 interfaces with the SS7 network 34 in a known manner.

The illustrated home network side 26 includes a home internet protocol network portion 48 having a radius 50 that is appropriately linked with the IP network 40 in a known manner. Further, a broker network 52 includes a radius 54 that communicates with the IP network 40 in a known manner.

The inventive arrangement facilitates providing packet data services to the user of the mobile station 22 even when the user roams into an area served by a visited access provider network that operates using a protocol different than the mobile subscriber's home network protocol. An interoperability and interworking function (IIF) 60 is associated with the SS7 network 34. The IF 60 facilitates communication of the subscriber profile information, including whether the subscriber has permission for packet data services, between the VLR 32 and the HLR 46. In one example, the IIF 60 maps a subscriber profile from the HLR 46 in the GSM/GPRS protocol to the ANSI-41 protocol used by the VLR 32. In another example, the IIF 60 translates the subscriber profile from one protocol to the other protocol. The inventive arrangement allows VLRs 32 using one protocol to obtain the necessary permission (i.e., authorization, authentication, registration or activation) from the GSM/GPRS HLR 46 in a manner that makes the permission valid in the protocol used by the VLR. In other words, the IIF 60 translates the service profile including a packet data service permission indicator from a GSM/GPRS HLR 46 to a second protocol VLR 32.

There are a variety of ways of translating or mapping the information from one protocol to another such that a subscriber profile and packet data service authorization conform to the requirements of the protocol used by the serving system side 24. Those skilled in the art who have the benefit of this description and know the requirements of the protocols with which they are dealing will be able to develop the necessary messages, sequence and timing to realize an effective communication that makes the service profile and packet data service authorization valid between different protocols.

One particular application of the inventive approach is for mapping a GSM subscriber service profile that includes a packet data service authorization from a GSM/GPRS HLR 46 to an ANSI-41 VLR 32 so that the mobile subscriber using the mobile station 22 obtains packet data services through the serving system 24. The provision of packet data services across the R-P interface between the radio access network controller 30 and the packet data serving node 36 and the IP network 40 occur in a known manner. Accordingly, the inventive arrangement provides CDMA packet data service in foreign mode.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of providing wireless data services, comprising:
communicating a service profile for a mobile subscriber that conforms to a GSM protocol including permission for packet data services in conformance with the requirements of a second protocol that is different from the GSM protocol such that the packet data permission is valid in the second protocol.

2. The method of claim 1, wherein the GSM protocol is a GSM/GPRS protocol and the second protocol is an ANSI-41 protocol.

3. The method of claim 1, including mapping the service profile and permission from the GSM protocol to the second protocol.

4. The method of claim 1, including translating the service profile and permission from the GSM protocol to the second protocol.

5. The method of claim 1, including obtaining the service profile from a home location register that uses the GSM protocol and providing the service profile in conformance with the second protocol to a remotely located visitor location register that uses the second protocol.

6. The method of claim 5, including communicating between the location registers using an IIF.

7. The method of claim 1, including receiving a request for packet data service from the mobile subscriber at a visitor location register and obtaining the permission that conforms to the GSM protocol from a remotely located home location register.

8. The method of claim 7, including transmitting the permission in conformance with the second protocol to the visitor location register.

9. The method of claim 8, including using an IIF to bring the GSM protocol permission into conformance with the second protocol.

10. The method of claim 1, wherein the permission includes at least one of an authorization for packet data services or an authentication for packet data services.

11. A method of using wireless data services by a mobile subscriber whose service profile conforms to a GSM protocol and includes permission for packet data services in the GSM protocol, comprising:
obtaining wireless data services through a network that uses a second protocol that is different from the GSM protocol, after the permission is brought into conformance with the requirements of the second protocol.

12. The method of claim 11, including roaming into an area not served by a network using the GSM protocol and requesting wireless data services in the area.

13. The method of claim 11, wherein the GSM protocol is a GSM/GPRS protocol and the second protocol is a CDMA/ANSI-41 protocol.

14. The method of claim 11, wherein the network using the second protocol obtains the GSM service profile from an IIF that maps the GSM protocol service profile to the second protocol such that the permission is considered valid for data services in the second protocol.
